(19) United States
(12) Patent Application Publication
(10) Pub. No.: US 2015/0142534 A1
(43) Pub. Date: May 21, 2015

(54) VEHICLE PARKING

(71) Applicant: SMART SHIP HOLDINGS LIMITED, Tortola (VG)

(72) Inventor: Billy Jay Junior SMART, Santa Monica (MC)

(21) Appl. No.: 14/600,170

(22) Filed: Jan. 20, 2015

Related U.S. Application Data
(63) Continuation of application No. PCT/EP2013/065134, filed on Jul. 17, 2013.
(60) Provisional application No. 61/673,946, filed on Jul. 20, 2012.

(30) Foreign Application Priority Data
Jul. 20, 2012 (GB) 1212903.7

(51) Int. Cl. G06Q 30/02

(52) U.S. Cl. CPC G06Q 30/0283
USPC 705/13

(57) ABSTRACT

A system and method of seeking payment for parking a vehicle in an area includes: detecting (202) a vehicle (104) in, or entering, an area (100); computing (206) a charge relating to the vehicle parking in the area, and processing (208) the computed charge in order to seek payment of the charge.

The present invention relates to parking of vehicles.

Parking a car in a car park or in an on-street space normally involves making a payment to an operator/owner of the property. This can be done manually by giving money to an employee; using a machine that requires coins or a payment card, or, in some cases, by contacting an automated payment scheme via telephone or SMS. All such existing schemes involve the driver having to spend time attending to the payment and in some cases can be particularly inconvenient if the driver does not have the correct coinage or does not have his mobile phone, for instance. Another problem with conventional parking arrangements is that some involve having to pay in advance for on-street parking: the user has to know, or guess, the minimum time he will need to park and often overpays to be safe.

A problem from the perspective of the owner/operator of parking facilities is improper re-use of parking vouchers/tickets, e.g. ones obtained from “pay and display” machines. When some drivers leave earlier than the expiry time/date of their ticket, they may give it to someone else to use, thereby depriving the owner/operator of revenue.

Paying for temporarily leaving other types of vehicles, including water or airborne vehicles, in storage bays/berths and the like can also be subject to similar inconveniences.

Embodiments of the present invention are intended to address at least some of the abovementioned problems. Embodiments of the system enable users to park in any available/appropriate area (as long as the space has not been pre-booked by another booking system, for example).

According to a first aspect of the present invention there is provided a method of seeking payment for parking a vehicle in an area, the method including or comprising:

detecting a vehicle in, or entering, an area;

computing a charge relating to the vehicle parking in the area, and

processing the computed charge in order to seek payment of the charge.

For the avoidance of doubt, the term “vehicle” used herein is intended to cover a wide range of transport, including vehicles that travel over/through land, water and/or air. A non-exhaustive list of examples includes cars, motorbikes, trucks, buses, aircraft and boats.

The method may include:

determining an identity of the vehicle and/or a user of the vehicle, and

obtaining payment information relating to the identified vehicle and/or the identified user.

The step of obtaining payment information may include referring to a data store including information linking vehicle identity (and/or user identity) with payment information, e.g. a database linking user/vehicle details with bank account/payment card details.

The method may further include:

recording an entry time when the vehicle was detected entering the area.

The method may further include:

detecting the vehicle leaving the area;

recording an exit time when the vehicle was detected leaving the area.

The step of computing the charge may include computing the charge based on the entry time and the exit time.

The method of seeking payment may include obtaining a payment authorisation from the user. The payment authorisation may be provided by the user entering a code using a device onboard the vehicle.

The step of determining an identity of the vehicle can include:

capturing at least one image of the vehicle, and

processing the at least one image in order to obtain a visual identifier of the vehicle, e.g. a registration or license plate.

Alternatively or additionally, the step of determining an identity of the vehicle can include obtaining an identification signal from a device (e.g. SatNav or computing device) fitted to or in the vehicle. The identification signal may be transferred wirelessly. The step of determining the identity of the vehicle may include comparing at least one visual characteristic associated with the vehicle in a data store with at least one corresponding visual characteristic of the vehicle in a said image.

The area may be divided, physically or notionally, into a plurality of sub-areas, each said sub-area being intended for parking of a vehicle.

The method may further include:

obtaining information regarding at least one dimension of the vehicle, and

defining a said sub-area having at least one dimension corresponding to the at least one obtained vehicle dimension.

The method may further include displaying a visual representation of the area or sub-area on a device onboard the vehicle. The method may further include displaying directions for the vehicle to park in the area or sub-area on the onboard device. The method may further include controlling at least one component of the vehicle to at least partially transport the vehicle into the area or sub-area.

If the step of processing the computed charge in order to seek payment of the charge cannot be successfully completed then the method may include generating a penalty for the vehicle and/or user of the vehicle. The method may include obtaining vehicle owner information based on a visual vehicle identifier in order to generate the penalty.

The method may include preventing or disrupting departure of the vehicle if payment of the charge has not been successfully completed. The method may include locking a component of the vehicle. The method may include controlling a mechanised clamp or barrier to prevent the vehicle from leaving the area. The method may include generating a warning if the vehicle attempts to leave the area without completing the payment of the charge. The method may include transferring data regarding vehicles which have (or have not) paid the charge to further devices, e.g. handheld device carried by traffic wardens/officers.

According to another aspect of the present invention there is provided a system including or comprising:

a vehicle detection device configured to detect a vehicle in, or entering, an area;

a computing device configured to compute a charge relating to the vehicle staying within the area, and

a computing device configured to process the computed charge in order to seek payment of the charge.

The system may further include at least one sensor fitted, in use, to the vehicle and/or at the area, the at least one sensor being in communication (directly or indirectly) with the vehicle detection device and/or the computing system. The at least one sensor may be used to determine if the vehicle is properly parked within the area.

The vehicle may include a road/land vehicle, a waterborne vehicle or an airborne vehicle. The area may comprise a car park. The car park may be divided into sub-areas by means of moveable barriers or moveable markings.

According to another aspect of the present invention there is provided a method of organising a vehicle parking area, the method including or comprising:

obtaining electronic data regarding a parking area, and

dividing the parking area into a plurality of sub-areas.

The method may further include:

obtaining information regarding at least one dimension of the vehicle, and

the step of dividing the parking area includes defining a said sub-area with at least one dimension regarding the at least one obtained vehicle dimension.

According to another aspect of the present invention there is provided a parking system including or comprising:

at least one vehicle detection device including, or linked to, a communications interface;

at least one remote computing system in communication with the at least one vehicle detection device.

The system may include at least one portable computing device including a communications interface, the portable computing device configured to transmit vehicle user and/or vehicle identity data to the vehicle detection device and/or the remote computing system.

The vehicle detection device may be used to determine if a said vehicle has been parked properly within the area.

The invention also covers systems configured to perform methods substantially described as herein. The invention also covers vehicles configured to interact with systems and methods as substantially as described herein.

According to another aspect of the present invention there is provided a computer program element comprising: computer code means to make the computer execute methods substantially as described herein. The element may comprise a computer program product.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments. As such, many modifications and variations will be apparent to practitioners skilled in the art. Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

The invention may be performed in various ways, and, by way of example only, embodiments thereof will now be described, reference being made to the accompanying drawings in which:

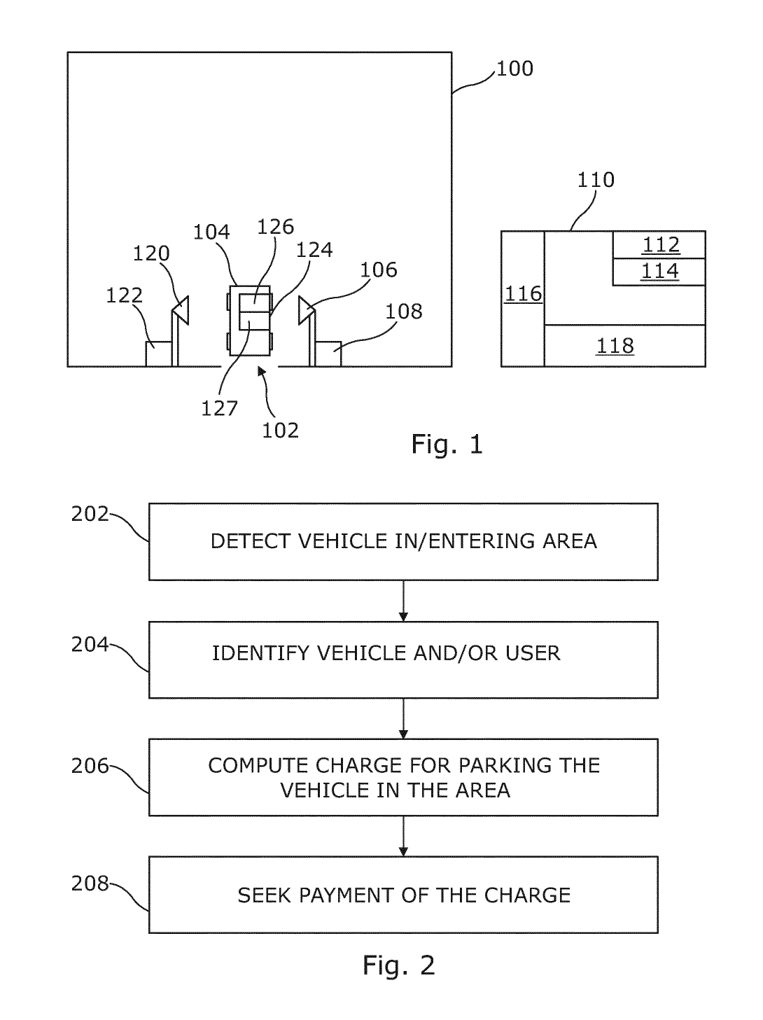

FIG. 1 is a schematic illustration of components of one embodiment of the system;

FIG. 2 is a flowchart illustrating steps performed by components of the system.

FIG. 1 shows an area 100 where a vehicle can stay temporarily in return for payment. In the example the area is a car park (which may be indoor or outdoor), but other examples of areas include stands/sheds for bicycles or motorcycles; marinas/berths for waterborne vehicles, hangars/gates/tie-downs/helipads for airborne vehicles, etc. Alternative embodiments of the system can be provided for such areas/vehicles. In another example, the area could be an on-street parking space. The area may be able to accommodate at least one vehicle and, in some cases, may be marked or constructed to define a plurality of distinct sub-areas. In some cases, the markings, etc, used to define distinct sub-areas may be flexible, e.g. moveable barriers that can be shifted (automatically in some cases) to accommodate vehicles of different sizes in use.

The area 100 can include an entrance 102, which in the example is a gateway (which may have access control means, such as a gate or barrier), but it will be understood that in other cases any (open/openable portion of any) edge of the area can function as an entrance/exit, and the entrance may not be physically marked. A vehicle in the form of car 104 is shown entering the area via the entrance.

There is at least one vehicle detection device 106 monitoring the area 100. The detection device can sense a vehicle present in (or entering) at least part of the area. In the example, the detection device 106 comprises a camera that can capture images (or video) continuously, intermittently or upon activation by, for example, a passive infra-red or movement detector. The camera includes, or is linked to, a computing device 108 that can receive the image data. In some cases the image data may be processed, e.g. converted from analogue to digital, encrypted and/or compressed by the computing device. The computing device can include a (wired or wireless) communications interface that allows it to exchange data, e.g. over the internet or Local Area Network, with a remote computing system 110. In alternative embodiments, at least some of the functions described herein performed by the remote computing system 110 may be executed by the camera computing device 108.

Large cities, such as London, already have many cameras (public and private) that could be used in conjunction with the system. Alternatively, additional image capture devices, e.g. webcams or automatically adjustable cameras, could be installed specifically for use with the system. It is also envisaged that other types of cameras, e.g. ones fitted on satellites, may be used to track and obtain information regarding vehicles. In some cases, this could require identifiers to be placed/marked on the roofs of vehicles in addition to standard number/license plates. The cameras may be “intelligent” to the extent that they can record data for future use so a car, which parks behind one car and in front of another, would have its registration plate retro-recorded (i.e. the camera might have the ability to temporarily hold data until the car has left the parking space, having paid, as will be described below). Therefore, if a vehicle parks between other vehicles (e.g. in front of one vehicle and behind another vehicle) so that its number plate cannot be seen by the camera/detection device when it is parked, then an image of the vehicle including its registration plate can still be stored and retrieved by the system in order to identify it. Some vehicles may park like this and then leave immediately, but may not be charged if the system operator wishes to give them a grace period. The grace period may be set by the operator and stored in the system, e.g. 2 to 5 minutes, or whatever length of time the car park owner/local council/operator, etc, wants to provide (if any).

In the example, the camera 106 captures images of a vehicle in/entering the area 100 and transfers images to the remote computing system 110 via the camera computing device 108. The remote computing system includes a processor 112, memory 114, communications interface 116 and user interface 118. It will be understood that in other embodiments, the functions performed by the remote computing system could be distributed over a plurality of computing platforms, e.g. a cloud computing system. The computing system may be located by/in the area 100 (e.g. an office) or may be located at premises belonging to an operator of the payment system.

FIG. 1 shows another vehicle detection device 120 that can detect a vehicle and/or assist with identifying it and/or an associated user in a different manner to camera 106. The device 120 can be used in addition to, or as an alternative to, the camera 106. In other embodiments, there may be a plurality of detection devices (which may be of the same or different types) located in and/or around the area 100, e.g. in order to fully cover a large/multi-storey car park or an entire street with on-street parking spaces.

The vehicle detection device 120 can include a wireless communications device 122 that can interact with a device onboard the vehicle 104 in order to identify it and/or an associated user. In some embodiments, the device 124 onboard the vehicle can comprise a (passive or active) Radio Frequency Identification device (RFID) and the device 122 is capable of receiving identity information from such a device. Any other suitable contact-based or contactless data transfer arrangement could also be used. The onboard device may be permanently or releasably fitted in the vehicle (in a location which may or may not be accessible to people in the vehicle). In yet another embodiment, the device 124 may be portable and carried by a user of the system (e.g. in the form of a card with a microprocessor, or an application running on a portable computing device, such as a mobile phone, PDA, laptop, a non-factory fitted SatNav/GPS, etc), rather than be attached to a particular vehicle. This can allow the user to drive and park several vehicles using the system without having to fit additional hardware to the vehicles.

In another embodiment, the device 124 onboard the vehicle can comprise a computing device including a processor and/or memory. The computing device could have functionality in addition to working with the payment system (e.g. it could be a SatNav/GPS system or the like), or it may be a discrete device that periodically, or upon request, transmits an identification signal without requiring any user interaction. The device can include a communications interface 126 that can exchange data with the remote computing system 110 and, in some cases, a user interface 127 that may include voice, touch screen, switch/button or any other user interface technology.

FIG. 2 is a flowchart showing example steps can be performed by the system illustrated in FIG. 1. It will be understood that in alternative embodiments some of the steps may be re-ordered and/or omitted. The steps can be implemented using any suitable programming language and data structures.

At step 202, the system detects a vehicle entering/being present in the area 100. This can be achieved using at least one of the detection devices 106, 120 or any other device(s). The user may park their vehicle within the area in accordance with any rules/regulations, e.g. within a marked bay, if the area includes such bays. In some cases, particular spaces within the area may be reserved for users of another payment system, e.g. a pre-booked parking system, such as that described in British patent applications no. 1115897.9 and no.1211970.7, and U.S. provisional patent application No. 61/668,215 (the contents of which are hereby incorporated by reference).

In some versions of the system (including ones that use conventionally-marked parking bays), the system may detect the vehicle entering a marked parking bay (e.g. by means of at least one sensor fitted on/around the bay and/or on the vehicle that is in communication with the onboard device 124, camera device 106/120 and/or remote computing system 110), or by taking an image that is subsequently processed to determine if the vehicle is properly within the bay. The cameras may have the virtual parking bays imprinted on their view finders (or the processing system can identify the boundaries in some other way), so they can detect whether the vehicle is correctly parked. If the vehicle is not properly within the bay then this may affect the charge calculated at step 206.

Alternatively, the area 100 may be divided into parking bays that are not physically marked, at least in a conventional manner by paint or the like. The lack of physical markings can have benefits in terms of reduced expense and reducing pollution due to paint, etc. This can allow parking spaces to be defined according to at least one specific dimension (e.g. length) of the vehicle, if so desired. The vehicle dimension data may be stored in the system's database (see below) or may be determined by analysing an image of the vehicle. In some embodiments, the device 124 onboard the vehicle may be used to guide the vehicle into a “virtual” parking space, e.g. by showing a visual representation of the virtual parking bay on its screen and/or (visual/audio) directions to it.

In some cases, an overhead image (possibly taken from a real-time feed from a satellite-based camera or the cameras 106, 120 at the area) of the vehicle and the surrounding area may be shown on the display of the device 124, on which markers/directions relating to the parking bay may be superimposed. When the vehicle is manoeuvring into the parking bay, the payment system components may interact with parking assist systems that are fitted on some vehicles to (assist with, or fully) guide the vehicle into the bay. In the case of a controlled environment, such when vehicles are sufficiently automated and can detect each other, etc, the driver can leave the vehicle at the parking area entrance and the system can interact with vehicle automation systems to guide the vehicle to the correct parking space.

Some embodiments of the system may have the ability to direct the user of a vehicle to an alternative parking space within the car park, or another available space on the street, e.g. if the size of the space turns out to be too small for the car; the user prefers to park at a different location for accessibility reasons, or if the user selects an option to notify him of available spaces in the vicinity of the current location of the vehicle. The system can relay the directions using the onboard device 124.

At step 204, the system attempts to identify the vehicle and/or user of the vehicle. In some embodiments, this can be achieved by transferring data from at least one detection device 106, 120 to the remote computing system 110, where the transferred data is processed. For example, image data captured by camera 106 can be transferred to the remote system, which includes Automatic Number Plate Recognition (ANPR) tools (or equivalent for US licence plates or other variants used worldwide) to extract a number plate from the image. Alternatively, the computing device 108/122 onboard the camera 106/120 could perform this function and transfer data relating to the extracted number plate to the remote system 110. Upon obtaining the number plate information, the remote system can attempt to identify a user and/or vehicle associated with that number plate. This can be achieved, for example, by searching a database of registered users of the payment system. If the identity of the vehicle indicates that it is not registered on the payment system then then the operator can choose how to handle this. For example, the vehicle user could be asked whether he would like to join the system (e.g. by being directed to the system's website) and/or he could be offered the option of paying in an alternative manner.

In alternative embodiments, at step 204, the system can seek to identify the user of the vehicle instead of, or in addition to, identifying the vehicle itself. For example, the camera 106 may be suitable to take a photograph of the face of the driver so that known image processing techniques can be used to recognise his face and retrieve a corresponding database record. Alternatively, a fingerprint or other biometric recognition device may be part of the system. In alternative embodiments, the user may identify themselves by logging into the system using an interface on vehicle device 124. In some cases, the system login may be linked to a user account on another system, such as Google Mail or Facebook, so that the user can set up the photograph to take a photograph/scan fingerprint of himself and store the data for later use. This could be useful if the user drives several different vehicles or rents different vehicles or is part of a vehicle club/share scheme or is a driver/passenger in a friend's vehicle and wants to charge the parking to his payment system account.

In some embodiments, the system may store further details regarding the vehicle/user that it can cross-check to confirm the identity of the vehicle/user for security. For instance, the database can store details of vehicles, such as make and model, colour, dimensions, etc, and the image can be analysed using known image processing techniques to check whether the vehicle captured by the camera 106 is the same as the one in the database. This can help prevent fraud based on use of false number plates, etc.

At step 206, the system can calculate a charge for the vehicle 104 being allowed to stay in the area 100. This charge may be calculated immediately after step 204 in some cases, e.g. where there is a fixed charge. In alternative embodiments, the charge may depend on other factors, such as the duration of the stay, the time of day (e.g. greater charge for peak hours than non-peak hours), the geographical location of the area, the dimension(s) of the vehicle, etc. In some cases, the user of the vehicle can give an indication to the user in advance of how long he intends to leave the vehicle in the area, e.g. by means of a user interface on the vehicle-based device 124, which then transfers the duration information to the remote system 110. In other embodiments, the system may detect the vehicle leaving the area, e.g. using a detection device 106, 120 (or, in some cases, another detection device, e.g. one located at an internal side of an exit barrier). The detection device can transfer information regarding the vehicle leaving the area (e.g. an image/identity of the vehicle and the time) to the remote system, which can then calculate the duration and an appropriate charge, e.g. the number of hours times an hourly rate, or any other time-based charging method, such as per-minute charging. If the operators of the payment system wish to give a grace period of say, 5 minutes, for cars who have pulled over to answer an emergency phone call, etc, then this can be accommodated and no charge is calculated and no payment is subsequently sought.

At step 208 the system seeks to obtain payment for the calculated charge. In some embodiments, this can involve seeking payment from a bank or payment card that is associated with the user/vehicle in the database and obtaining payment from that source using known money transfer/payment techniques. In some embodiments, the payment system can include its own credits account, which a user can “top up” with money in advance. This can appeal to users who do not wish to let their bank account/card be directly accessed by the system each time they pay. In some cases, the payment may be processed without further interaction with the user. In other cases, the user may be asked to provide confirmation of the payment, e.g. via the onboard device 124 by keying in a payment card PIN or the like (the details of which can be securely stored in the system's database). In some cases, the system can allow a user to set their preferences for such interactions via configurable user preferences linked to their account, which are stored in the system's database. If the device 124 is set up to ask for the user's card PIN (some users may not wish to have this automated), then it can ask for these details at the time the car is parked, or as soon as the car is started before being driven away.

If the payment system does not receive confirmation that payment has been received then details of the vehicle (e.g. registration and/or image, etc) can be stored for non-payment processing. In cases where the vehicle/user is registered with the payment system and payment has not been successful then the system can send a penalty notice or the like to the relevant person associated with the vehicle based on its database record. If the vehicle/user is not registered on the system (e.g. identification step 204 failed) then it can communicate with the Driver Vehicle Licensing Agency (or similar authorities) or any other appropriate source to obtain contact details. In some cases, an alternative/conventional payment method may be offered alongside the system described herein (which may be linked to the system 110 so that a penalty is not generated, etc, if the user has paid using the alternative payment system). The charge tariffs may be different for different payments systems. Alternatively, the system may process details of all vehicles that have used registered areas during a particular time frame, match these up with dates and times of vehicles which have paid and by a process of elimination obtain a list of vehicles that have not paid and process these accordingly.

The vehicle 104 and/or the area 100 may be configured to prevent/disrupt departure of the vehicle until payment has been successfully processed. For example, the system may be able to access a lock feature on the gearbox or other component of the vehicle, or the area may include a mechanised clamp or barrier, in order to prevent drivers moving away without successful payment being received. Alternatively or additionally, the device 124 can be configured to produce a warning if the driver attempts to leave without completing the payment.

In another embodiment, data representing confirmation regarding which vehicles have paid can be sent from the payment system to handheld devices carried by traffic wardens, police, private wheel clampers, tow trucks, DVLA, local councils, etc or any other equivalent organisation/authority, etc, in any country (the payment can still be automatic, as the car device 124 can be updated to know when it is in a parking area, even if parking authorities choose not to have the parking space monitoring systems), so that the traffic warden knows which cars have not paid and therefore which are to receive penalties in a conventional manner. Alternatively, the traffic wardens can be sent a list of vehicles that have paid. The traffic warden can issue non-paying vehicles with a penalty directly, or confirm the details of the vehicle to the payment system so that the system sends them a ticket.

1. A method of seeking payment for parking a vehicle in an area, the method including:
detecting (202) a vehicle (104) in, or entering, an area (100);
computing (206) a charge relating to the vehicle parking in the area, and processing (208) the computed charge in order to seek payment of the charge.

2. A method according to claim 1, further including:
determining (204) an identity of the vehicle and/or a user of the vehicle, and
obtaining (208) payment information relating to the identified vehicle and/or the identified user.

3. A method according to claim 2, wherein the step of obtaining (208) payment information includes referring to a data store including information linking vehicle identity (and/or user identity) with payment information.

4. A method according to claim 1, further including: recording an entry time when the vehicle was detected entering the area.

5. A method according to claim 4, further including:
detecting the vehicle leaving the area;
recording an exit time when the vehicle was detected leaving the area.

6. A method according to claim 5, wherein the step of computing (206) the charge includes computing the charge based on the entry time and the exit time.

7. A method according to claim 1, including obtaining a payment authorisation from the user.

8. A method according to claim 7, wherein the payment authorisation is provided by the user entering a code using a device (124) onboard the vehicle (104).

9. A method according to claim 2, wherein the step of determining (204) the identity of the vehicle (104) includes:
capturing at least one image of the vehicle, and
processing the at least one image in order to obtain a visual identifier of the vehicle, e.g. a registration or license plate.

10. A method according to claim 2, wherein the step of determining (204) the identity of the vehicle (104) includes obtaining an identification signal from a device (124) fitted to or in the vehicle.

11. A method according to claim 10, wherein the identification signal is transferred wirelessly.

12. A method according to claim 9, wherein the step of determining (204) the identity of the vehicle (104) includes comparing at least one visual characteristic associated with the vehicle in a data store with at least one corresponding visual characteristic of the vehicle in a said image.

13. A method according to claim 1, wherein the area (100) is divided, physically or notionally, into a plurality of sub-areas, each said sub-area being intended for parking of a vehicle.

14. A method according to claim 13, further including:
obtaining information regarding at least one dimension of the vehicle (104), and
defining a said sub-area having at least one dimension corresponding to
the at least one obtained vehicle dimension.

15. A method according to claim 14, further including displaying a visual representation of the area (100) or sub-area on a device (124) onboard the vehicle (104).

16. A method according to claim 15, further including displaying directions for the vehicle (104) to park in the area (100) or sub-area on the onboard device (124).

17. A method according to claim 16, further including controlling at least one component of the vehicle (104) to at least partially transport the vehicle into the area (100) or sub-area.

18. A method according to claim 1, wherein if the step of processing (208) the computed charge in order to seek payment of the charge is not successfully completed then the method includes generating a penalty for the vehicle and/or user of the vehicle.

19. A method according to claim 18, including obtaining vehicle owner information based on a visual vehicle identifier in order to generate the penalty.

20. A method according to claim 18, including preventing or disrupting departure of the vehicle (104) if payment of the charge has not been successfully completed.

21. A method according to claim 20, including locking a component of the vehicle (104).

22. A method according to claim 20, including controlling a mechanised clamp or barrier to prevent the vehicle (104) from leaving the area (100).

23. A method according to claim 20, including generating or displaying a warning if the vehicle (104) attempts to leave the area (100) without completing the payment of the charge.

24. A method according to any claim 1, including transferring data regarding vehicles which have (or have not) paid the charge to further devices, e.g. handheld device carried by traffic wardens/officers, etc.

25. A system including:
a vehicle detection device (106, 120) configured to detect a vehicle (104) in, or entering, an area (100);
a computing device (110) configured to compute (206) a charge relating to the vehicle staying within the area, and
a computing device (110) configured to process (208) the computed charge in order to seek payment of the charge.
